(19) United States
(12) Patent Application Publication
(10) Pub. No.: US 2023/0109653 A1
(43) Pub. Date: Apr. 6, 2023

(54) CONVEYOR DISCHARGE CHUTE WITH DIVERTING PADDLES

(71) Applicant: Laitram, L.L.C., Harahan, LA (US)

(72) Inventors: Nischal Nath Pant, New Orleans, LA (US); Mark Costanzo, New Orleans, LA (US)

(21) Appl. No.: 17/913,533

(22) PCT Filed: Apr. 9, 2021
(86) PCT No.: PCT/US2021/026631

§ 371 Date: Sep. 22, 2022

Related U.S. Application Data
(60) Provisional application No. 63/016,396, filed on Apr. 28, 2020.

(51) Int. Cl. B65G 11/02; B65G 11/12; B65G 11/20; B65G 47/46

(52) U.S. Cl. CPC B65G 11/023; B65G 11/123; B65G 11/203; B65G 47/46

(57) ABSTRACT

Diverting paddles (72) on discharge chutes guide packages into multiple destination receptacles (22, R1) assigned to the package. The paddles (38, 72) can present static or driven flat outer surfaces or static or driven roller surfaces to the packages. The paddles (38, 72) block packages from entering non-assigned receptacles (22, 24, R1). The chutes may be made tillable to feed packages into receptacles (22, 24, R1) at different elevations.

### BACKGROUND

The invention relates generally to power-driven conveyors and more particularly to sorting conveyors having discharge chutes with diverting paddles.

In various industries, such as package-handling, sorting conveyors are used to sort packages off one or both sides onto discharge conveyors such as chutes or slides. Each discharge conveyor deposits its packages into a collection receptacle, which must be replaced or emptied when full. If a receptacle is not emptied when full, packages destined for the receptacle fall onto the floor.

### SUMMARY

A chute embodying features of the invention comprises an outer face declining downward from an upper end to a lower end and extending in width from a first side to a second side and a first diverting paddle having a pivot end and an opposite distal end. The first diverting paddle is pivotable along the outer face at the pivot end from a first position in which the first diverting paddle blocks packages advancing down the outer face from exiting a first portion of the lower end to a second position in which the first diverting paddle does not block packages advancing down the outer face from exiting the first portion of the lower end.

### BRIEF DESCRIPTION OF THE DRAWINGS

FIG. 1 is a top plan view of a schematic drawing of a conveyor system embodying features of the invention.

FIG. 2 is a front elevation view of the conveyor system of FIG. 1.

FIG. 3 is an isometric view of a discharge chute embodying features of the invention including a diverting paddle to selectively deliver packages to two adjacent receptacles.

FIGS. 4A and 4B are front elevation views of the discharge chute of FIG. 3 in two different positions.

FIGS. 5A and 5B are axonometric views of a discharge chute as in FIG. 3 further having a motor to tilt the chute to selectively deliver packages to four receptacles.

FIG. 6 is an isometric view of a diverting paddle for a discharge chute as in FIG. 3 or in FIGS. 5A and 5B with rollers contacting the packages.

FIG. 7 is an isometric view of a diverting paddle for a discharge chute as in FIG. 3 or in FIGS. 5A and 5B with a powered belt contacting the packages.

FIG. 8 is an isometric view of a discharge chute embodying features of the invention including two diverting paddles to deliver packages to three receptacles.

FIGS. 9A and 9B are consecutive front elevation views of the discharge chute of

FIG. 8 with the paddles in position to direct packages to a left receptacle.

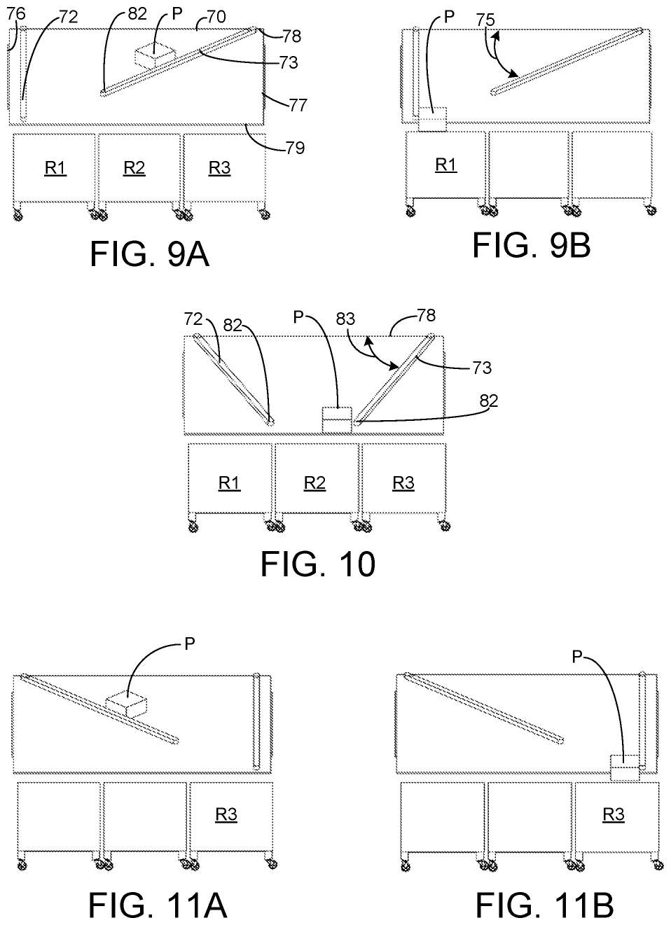

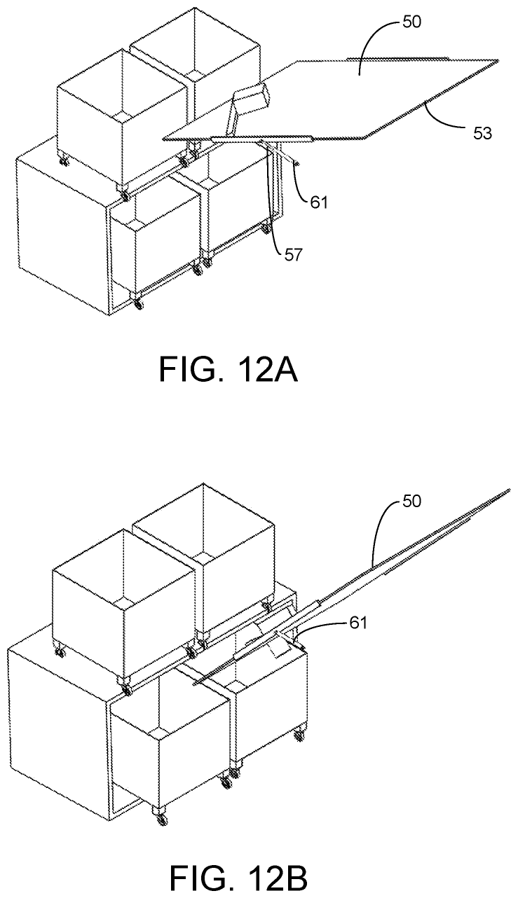

FIG. 10 is a front elevation view as in FIGS. 9A and 9B with the paddles in position to direct packages to a middle receptacle.

FIGS. 11A and 11B are front elevation views as in FIGS. 9A and 9B with the paddles in position to direct packages to a right receptacle.

FIGS. 12A and 12B are axonometric views of a discharge chute as in FIGS. 5A and 5B with a linear actuator tilter.

### DETAILED DESCRIPTION

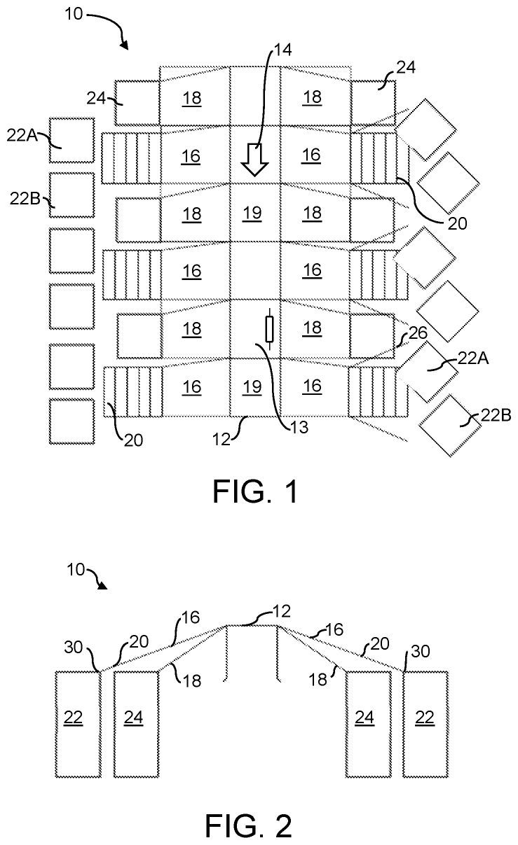

Schematic views of a conveyor system embodying features of the invention are shown in FIGS. 1 and 2. The conveyor system 10 includes a power-driven main conveyor 12 conveying articles in a main conveying direction 14. The main conveyor 12, which may be a belt conveyor, a tray conveyor, a slat conveyor, or a powered-roller conveyor, is flanked on both sides by discharge conveyors 16, 18. One example of a main conveyor is the Intralox® ARB Sorter S7000 sorting conveyor manufactured and sold by Intralox, L.L.C., Harahan, Louisiana, U.S.A. A sorting system composed of sorting diverters 19 at the entrance to each discharge conveyor 16, 18 selectively sorts packages off the sides of the main conveyor 12 transverse to the main conveying direction 14 and onto a discharge conveyor or allows packages to pass through to downstream sorting diverters. In this version some of the discharge conveyors 16 include a diverter 20. The diverter 20 selectively diverts articles to one or the other of its destination receptacles 22: 22A, 22B. If an odd number of receptacles associated with a common destination are used, other discharge conveyors 18 without diverters can be used to deliver packages directly into single receptacles 24. If necessary, walls 26 on opposite sides of the diverters 20 can be used to prevent diverted packages from missing the selected receptacles 24.

As shown in FIG. 2, each discharge conveyor 16, 18 may be angled downward on a decline toward the receptacles 22, 24. The diverters 20 include a slide or chute along which packages advance by gravity. The diverter 20 at the exit end of each discharge conveyor 16 is angled downward. Its upper end 28 receives packages sorted onto the discharge conveyor 16 from the main conveyor 12. The articles, under the influence of gravity, roll or slide down the chute of the declining diverter 20 and off its lower end 30 and into a destination receptacle 22. The chute may be a flat slide or an array of rollers down which packages advance with less friction.

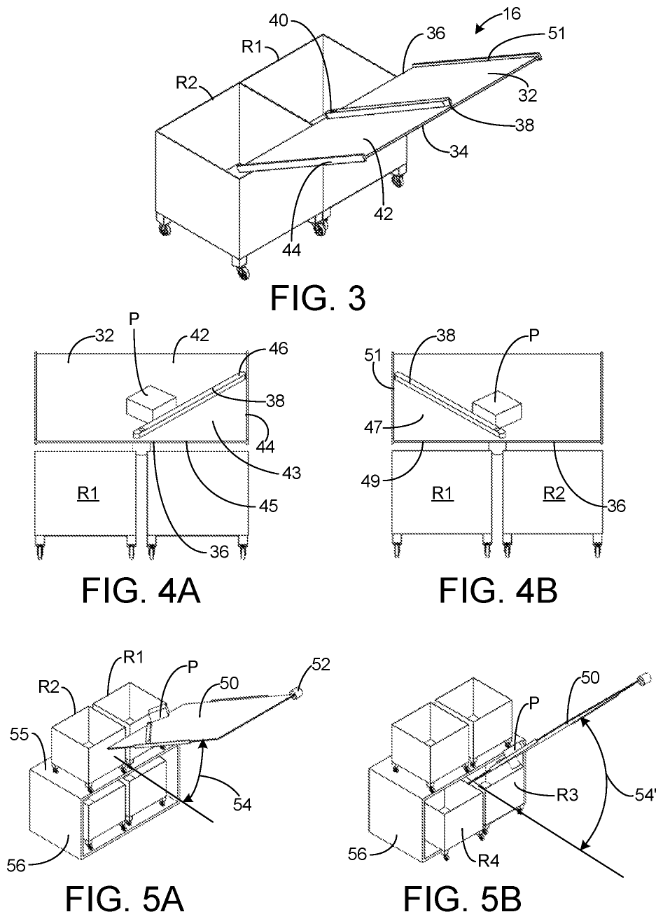

Details of the discharge conveyor 16—a chute 32 in this example—are shown in FIG. 3. The chute 32 has an outer face 42 that declines downward from an upper end 34 to a lower end 36 and extends across the width of the chute from a first side 44 to a second side 51. The lower end 36 is positioned above a pair of side-by-side receptacles R1, R2. A diverting paddle 38 is attached by a pin 40 that extends through the chute 32 near its lower end 36—a pivot end—to a motor (not shown) on the underside of the chute. The pivot pin 40 is shown on the centerline of the chute 32 midway between the first and second sides 44, 51 and aligned with the gap between the receptacles R1, R2. The motor pivots the paddles 38 along the outer face 42 of the chute 32 at the pivot end 36 to guide packages into an assigned destination receptacle R1, R2 and to block packages from entering an unassigned destination receptacle. The paddles 38 are at or just enough above the outer face 42 to avoid scraping the outer face without allowing packages to jam or pass beneath the paddles.

As shown in a first position in FIG. 4A, the diverting paddle 38 is pivoted clockwise obliquely across the chute 32 toward the chute's right side 44 to guide a package P into the left-hand receptacle R1. The distal end 46 of the paddle 38 is close enough to the right side 44 of the chute 32 for the paddle to intercept any packages fed onto the right half of the chute and guide them down a first side of the chute's outer face 42 and off its lower end 36 and into the left-hand receptacle R1. Some packages fed onto the left half of the chute 32 may advance down the chute to the left-hand receptacle R1 without contacting the paddle 38. In the first position the diverting paddle 38 prevents packages P from entering a right-side region 43 of the outer surface 42 of the chute 32 bounded by the paddle, the right side 44 of the chute, and a first right-side portion 45 of the lower end 36. So packages P are blocked from exiting the chute 32 over the first portion 45 of the lower end 36. FIG. 4B shows the paddle 38 pivoted counterclockwise to extend obliquely across the chute 32 in a second position preventing packages P from entering a left-side region 47 of the outer surface 42 of the chute 32 bounded by the paddle, the left side 51 of the chute, and a second left-side portion 49 of the lower end 36. In that way the paddle 38 in the second position blocks the left-hand receptacle R1 and guides packages P that come into contact with an opposite second side of the paddle into the right-hand receptacle R2.

Another version of a chute discharge is shown in FIGS. 5A and 5B. The chute 50 is similar to the chute 32 of FIG. 3, except that it includes a tilt motor 52 coupled to a hinge at an upper end of the chute to change the tilt angle of the chute and the elevation of the lower end of the chute's outer face. In FIG. 5A the chute 50 is tilted about its upper end at a shallow tilt angle 54 to selectively deliver packages P to one or the other of two receptacles R1, R2 at a first elevation atop a support surface 55, such as a shelf or roof of an enclosure 56. In FIG. 5B the chute 50 is shown tilted in a second position at a greater tilt angle 54′ to deliver packages P to one or the other of two lower receptacles R3, R4 protruding from an open side of the enclosure 56 at a lower second elevation. The lower destination receptacles R3, R4 can be maintained in their positions shown in FIG. 5B protruding out of the enclosure 56 and inward toward the chute 50 a greater distance than the upper receptacles R1, R2. Or the lower receptacles can be selectively driven from a recessed position inside the enclosure 56 as in FIG. 5A to a protruding position as in FIG. 5B to receive packages and then back again. Means other than the tilt motor 52 can be used to tilt the chute about its hinged upper end to change the elevation of its lower end. For example, as shown in FIGS. 12A and 12B, a linear actuator 51, such as a pneumatic cylinder, has an arm 57 that is attached to a lateral side of the chute 50. A second similar actuator could also be similarly attached to the opposite lateral side. Or an actuator could be attached to the underside of the chute 50. Although not shown, the other end of the actuator 51 is attached to a fixed part of the conveyor frame. The actuator is used to tilt the chute 50 about its upper end 53. In FIG. 12A the chute 50 is tilted at a shallow angle by the actuator's extended arm 57 to deliver packages to one of the upper receptacles; in FIG. 12B the chute is tilted at a steeper angle by the actuator's retracted arm to deliver packages to one of the lower receptacles. Another example of means to tilt the chute is a pulley system attached to one or both sides of the chute.

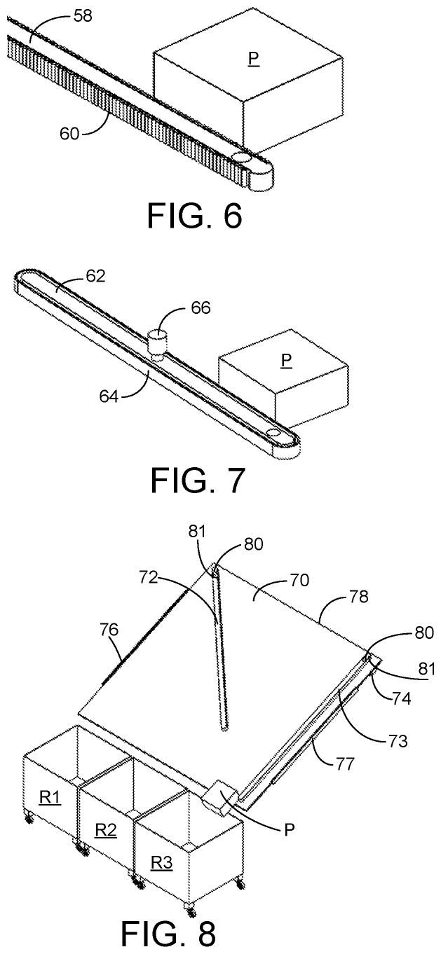

FIG. 6 shows a diverting paddle 58 usable with any of the chutes. The paddle 58 has a series of rollers 60 whose axes of rotation are perpendicular to the outer face of the chute.

The rollers 60 may be passive or be actively rotated. The rollers 60 can be static or mounted in a powered roller belt, such as an INTRALOX® Series 1400 Roller Top belt. The rollers 60 form the outer surface of the paddle and contact the packages P in rolling contact, rather than sliding contact, to reduce friction and minimize damage to the contacting sides of the packages and to prevent packages from stalling as they advance down the chute.

The diverting paddle 62 of FIG. 7 has a powered belt 64 forming the outer surface of the paddle. A motor 66 drives the belt 64, running on edge around the paddle 62, to help advance packages P along the paddle with minimal friction and down the chute.

FIG. 8 shows a chute 70 with two diverting paddles 72, 73 to selectively guide packages P into one of three destination receptacles R1, R2, R3. Each paddle 72, 73 is attached to a corresponding motor 74 at the underside of the chute 70 at each side 76, 77 near the upper end 78 by a pivot pin 80, such as the motor's shaft. Pivot ends 81 of the paddles 72, 73 are equidistant from the upper end 78 of the chute 70. FIGS. 9A and 9B show the paddles 72, 73 in a first position to guide packages P into the left-hand receptacle R1. In the first position, the left-hand paddle 72 is parallel to the left side 76 of the chute 70, and the right-hand paddle 73 extends at a first oblique angle 75 relative to the upper end 78 from the pivot end 81 toward the lower end 79 and the left side 76. The distal end 82 of the right-hand paddle 73 is positioned laterally far enough to block packages from entering the middle and right-hand receptacles R2, R3. The pivot ends 81 of the paddles 72, 73 are close enough to the left and right sides 76, 77 to prevent packages from fitting between the pivot ends and the nearer side. The chute 70 can be made to tilt up and down like the chute 50 of FIGS. 5A and 5B by the addition of a tilt motor to sort packages to multiple levels of receptacles.

In FIGS. 11A and 11B the paddles 72, 73 are shown in a second position guiding packages P into the right-hand receptacle R3. In this position the paddles 72, 73 are arranged as mirror images of the paddles in the first position shown in FIGS. 9A and 9B.

In FIG. 10 the paddles 72, 73 are shown in a third position with their distal ends angled toward each other at a second oblique angle 83 relative to the upper end 78 to funnel packages P into the middle receptacle R2. The second oblique angle 83 is greater than the first oblique angle 75 shown in FIG. 9B. The paddles 72, 73 in the third position block packages P from entering the left- and right-hand receptacles R1, R3.

A controller for the conveyor system executes program steps stored in the controller's program memory to identify each package, to assign each package's destination, monitor position sensors throughout the conveyor system to track each package, to control the conveyor drive motors, the diverters, and the paddles, and to perform diagnostic, reporting, and alarm functions.

Although the description and claims refer to packages as the conveyed item, packages is used as a generic term for any object that can be conveyed and sorted on the equipment described. Examples include parcels, envelopes, bags, boxes, cartons, containers, and unpackaged products. And the destination receptacles can be bins, totes, bags, platforms, and other receptacles capable of holding packages, for example.

What is claimed is:

1. A chute comprising:
an outer face declining downward from an upper end to a lower end and extending in width from a first side to a second side;
a first diverting paddle having a pivot end and an opposite distal end, wherein the first diverting paddle is pivotable along the outer face at the pivot end from a first position in which the first diverting paddle blocks packages advancing down the outer face from exiting a first portion of the lower end to a second position in which the first diverting paddle does not block packages advancing down the outer face from exiting the first portion of the lower end.

2. The chute of claim 1 wherein the first diverting paddle in the second position blocks packages advancing down the outer face from exiting a different second portion of the lower end.

3. The chute of claim 2 wherein, in the first position, the first diverting paddle blocks packages from entering a first blocked region of the outer face bounded by the first diverting paddle, the first side of the outer face, and the first portion of the lower end and wherein, in the second position, the first diverting paddle blocks packages from entering a second blocked region of the outer face bounded by the first diverting paddle, the second side of the outer face, and the second portion of the lower end.

4. The chute of claim 1 wherein the distal end of the first diverting paddle in the first position is closer to the first side of the outer face than is the pivot end and wherein the distal end of the first diverting paddle in the second position is closer to the second side of the outer face than is the pivot end.

5. The chute of claim 1 wherein the first diverting paddle extends obliquely across the outer face in the first and second positions.

6. The chute of claim 1 wherein the pivot end of the first diverting paddle is closer to the lower end of the outer face than to the upper end and midway between the first and second sides.

7. The chute of claim 1 wherein the first diverting paddle includes a series of rollers forming an outer surface of the first diverting paddle contacting packages.

8. The chute of claim 1 wherein the first diverting paddle includes a motor and a flat belt driven on edge by the motor and forming an outer surface of the first diverting paddle contacting packages.

9. The chute of claim 1 comprising a second diverting paddle having a pivot end and an opposite distal end, wherein the pivot end of the second diverting paddle is positioned close enough to the second side of the outer face to prevent packages from fitting between the pivot end and the second side and wherein the pivot end of the second diverting paddle is closer to the upper end of the outer face than is the distal end, and wherein the pivot end of the first diverting paddle is positioned close enough to the first side of the outer face to prevent packages from fitting between the pivot end and the first side and wherein the pivot end of the first diverting paddle is closer to the upper end of the outer face than is the distal end.

10. The chute of claim 9 wherein the pivot ends of the first and second diverting paddles are equidistant from the upper end of the outer face.

11. The chute of claim 9 wherein:
in the first position of the first and second diverting paddles, the first diverting paddle is angled relative to the upper end of the outer face toward the second side at a first oblique angle and the second diverting paddle is parallel to the second side of the outer face to guide packages off the lower end near the second side;
in a second position of the first and second diverting paddles, the second diverting paddle is angled relative to the upper end of the outer face toward the first side at the first oblique angle and the first diverting paddle is parallel to the first side of the outer face to guide packages off the lower end near the first side; and
in a third position of the first and second diverting paddles, the first and second diverting paddles are angled relative to the upper end toward each other at a second oblique angle greater than the first oblique angle to funnel packages off the middle of the lower end.

12. The chute of claim 1 comprising a motor coupled to chute at the upper end of the outer face to tilt the chute to different chute angles and change the elevation of the lower end of the outer face.

13. The chute of claim 1 comprising a linear actuator coupled to chute to tilt the chute to different chute angles and change the elevation of the lower end of the outer face.
